(19) United States
(12) Patent Application Publication
(10) Pub. No.: US 2026/0291727 A1
(43) Pub. Date: Sep. 24, 2026

(54) Safety Governance System for Regulating Continuity-Based Session Restoration Across Heterogeneous User-Interface Nodes

(71) Applicant: ALEXANDER JOHN BRACKEN, DUBAI (AE)

(72) Inventor: ALEXANDER JOHN BRACKEN, DUBAI (AE)

(21) Appl. No.: 19/693,456

(22) Filed: May 31, 2026

Related U.S. Application Data
(63) Continuation-in-part of application No. 19/418,946, filed on Dec. 13, 2025.
(60) Provisional application No. 63/913,268, filed on Nov. 7, 2025.
(60) Provisional application No. 63/913,146, filed on Nov. 7, 2025.
(60) Provisional application No. 63/914,032, filed on Nov. 8, 2025.
(60) Provisional application No. 63/921,315, filed on Nov. 20, 2025.
(60) Provisional application No. 63/930,668, filed on Dec. 3, 2025.
(60) Provisional application No. 63/930,661, filed on Dec. 3, 2025.

(51) Int. Cl. H04L 9/08; H04L 9/32

(52) U.S. Cl. CPC H04L 9/0891; H04L 9/0894; H04L 9/3213; H04L 9/3231; H04L 9/3247

(57) ABSTRACT

A safety governance system for regulating continuity-based session restoration across heterogeneous user-interface nodes. A continuity anchor device locally executes continuity token derivation, encrypted memory indexing, and continuity restoration. A safety governance layer monitors biometric indicators, user consent, and tamper conditions, detects safety conditions including distress, inactivity, tamper, and absence using locally evaluated thresholds, and initiates irreversible cryptographic erasure of continuity tokens and encrypted memory upon satisfaction of a safety revocation threshold by wiping decryption keys. Safety threshold evaluation uses stabilized representations within secure enclaves derived from fuzzy extractors or secure sketches. A safety lock state suspends continuity restoration until released by locally validated cryptographic reset using locally stored key material. Remote policy enforcement, centralized identity provider authentication, and external recovery mechanisms are insufficient to authorize continuity restoration or release the safety lock state absent locally validated cryptographic authorization. Safety governance executes locally without network connectivity as a prerequisite.

### CROSS-REFERENCE TO RELATED APPLICATIONS (CONTINUATION-IN-PART)

This application is a continuation-in-part of U.S. non-provisional patent application Ser. No. 19/418,946, filed Dec. 13, 2025, titled “Systems and Methods for Biometric Continuity Token-Based Conversational Continuity Across Interfaced Computing Devices” (“Parent Application”). The specification of the Parent Application is reproduced herein, and new matter directed to a safety governance layer is introduced in Section 6.15 of the Detailed Description below.

This application claims the benefit of priority to the following U.S. Provisional Patent Applications (as identified in the Parent Application), each incorporated by reference in its entirety for all purposes:
U.S. Provisional Application No. 63/930668, filed Dec. 3, 2025
U.S. Provisional Application No. 63/930661, filed Dec. 3, 2025
U.S. Provisional Application No. 63/921315, filed Nov. 20, 2025
U.S. Provisional Application No. 63/914032, filed Nov. 8, 2025
U.S. Provisional Application No. 63/913268, filed Nov. 7, 2025
U.S. Provisional Application No. 63/913146, filed Nov. 7, 2025

### STATEMENT REGARDING FEDERALLY SPONSORED RESEARCH

Not Applicable.

### SEQUENCE LISTING

Not Applicable.

### INCORPORATION BY REFERENCE/SPECIFICATION

The Specification of the Parent Application (U.S. non-provisional patent application Ser. No. 19/418,946, filed Dec. 13, 2025), including the Abstract, Background, Summary, Brief Description of Drawings, Detailed Description, and Drawings, is incorporated herein by reference in its entirety. Certain subject matter from the Parent Application is reproduced herein, and this application further includes continuation-in-part subject matter directed to the safety governance system described in Section 6.15 and the claims.

### FIELD OF THE INVENTION

The present disclosure relates generally to computer-implemented biometric security systems and continuity architectures and, more particularly, to systems and methods for maintaining persistent user-interactive session continuity across multiple computing interfaces through locally derived biometric or interaction-based identity tokens without reliance on centralized cloud identity services or persistent remote memory repositories.

### CROSS-REFERENCE TO RELATED APPLICATIONS

This application claims priority to the provisional applications identified in the “Cross-Reference to Related Applications” section above, each of which is incorporated herein by reference in its entirety.

### BACKGROUND OF THE INVENTION

Modern interactive computing platforms depend heavily on remote authentication servers, persistent cloud user accounts, centralized identity providers, and cloud-based memory repositories to maintain continuity of services and conversational state across devices. These architectures introduce substantial privacy risks, data leakage concerns, identity theft exposure, platform lock-in dependencies, jurisdictional regulatory conflicts, and service discontinuity failures during network outages, device transitions, or account deactivation events.

Existing biometric authentication systems typically require permanent storage of raw biometric identifiers or depend on centralized biometric comparison networks. These approaches introduce long-term privacy and security risks and make true user ownership of personal identity and continuity technically difficult or infeasible. Users must often trust external parties to retain, protect, and control access to deeply personal identity data.

Conversational and generative AI systems increasingly span heterogeneous platforms, including wearable devices, vehicles, robotic systems, entertainment systems, satellite terminals, mobile devices, and neural interface endpoints. However, current solutions provide no effective means of securely preserving conversational or contextual continuity across such platforms without remote tracking of user identity, persistent account structures, or cloud-stored memory repositories. The resulting architectures are highly centralized, network dependent, and vulnerable to single points of failure.

Prior art in related fields includes wearable-based health monitoring, biometric authentication devices, conversational AI orchestration, distributed transaction platforms, and low-latency communication systems. For example, prior art discloses systems for: wearable body temperature monitoring, health and fitness tracking, biometric authentication, micro-transaction processing in games or chatbots, monetization of user data, latency prediction in gaming, low-latency network optimization, and distributed AI service orchestration. Such systems often depend on cloud-based processing, account-based identity, or centralized server coordination and do not disclose or suggest:
local, non-invertible biometric or interaction-signal-derived continuity tokens generated on a user-associated anchor device;
encrypted continuity memory stored solely under control of that anchor device;
offline restoration of conversational or interactive continuity across heterogeneous interface nodes without cloud-hosted identity profiles or remote memory; and
protocol-based, distributed continuity synchronization operating independently of centralized identity directories.

Accordingly, there remains a need for systems and methods capable of enabling seamless continuity of user interaction across diverse interfaces while preserving privacy through local identity derivation, eliminating reliance on persistent cloud identity architectures, enabling offline operational capability, and supporting both biometric and non-biometric continuity for human users and digital agents.

### SUMMARY OF THE INVENTION

The present disclosure provides systems and methods for maintaining persistent continuity of conversational or user-interactive computing sessions across multiple interfaced devices through the use of a continuity anchor device. The continuity anchor device acquires biometric or interaction-derived signals, derives anonymized non-invertible continuity tokens locally without permanent storage or transmission of raw biometric data, and indexes encrypted session context and continuity state data to the derived tokens.

By implementing continuity token derivation, encrypted session storage, and continuity restoration exclusively on the continuity anchor device without reliance on cloud identity services, the present disclosure improves computer system security and reliability, reduces network resource usage, and maintains interactive continuity during network and account outages.

In doing so, the disclosed systems and methods improve the functioning of computer-based interactive platforms by reducing reliance on centralized authentication servers, eliminating single points of failure in session continuity, and enabling secure state restoration even in the absence of network connectivity.

A locally encrypted memory store resident on or controlled by the continuity anchor device retains continuity state, conversational fragments, user preferences, and interaction metadata associated with the token. Upon re-detection of a valid token following interruption events such as disconnection, device handover, lapse of interaction, power cycling, idle periods, or interface transitions, a continuity restoration engine automatically restores session context without requiring network-based authentication, cloud data access, or persistent user account retrieval.

One or more conversational or user-interface nodes implemented across wearable devices, vehicles, robotic platforms, satellite terminals, mobile devices, audiovisual systems, fixed installations, neural interface endpoints, or cloud-hosted conversational systems exchange user-interactive data with the continuity anchor device. These nodes rely on ephemeral continuity token references and do not require persistent storage of personal identity records or biometric data.

The system may operate entirely locally or in decentralized and hybrid configurations, eliminating persistent cloud storage of biometric identifiers or user interaction memory. In certain embodiments, neural-adjacent or physiological activity patterns detected during low-interaction or sleep states may be buffered locally without semantic interpretation and later correlated with waking interactions to provide subtle, non-explicit continuity assistance cues such as prompts or recall reinforcement.

In other embodiments, the system implements a distributed continuity synchronization protocol defining continuity token message formats, cryptographically authenticated handshake sequences, reconciliation rules, and restoration priorities, enabling continuity synchronization across heterogeneous computing platforms and vendor ecosystems without centralized identity directories.

### BRIEF DESCRIPTION OF THE DRAWINGS

FIG. 1 illustrates a general system architecture showing a continuity anchor device interacting with multiple user-interface nodes through locally derived continuity tokens.

FIG. 2 illustrates a signal flow diagram depicting biometric or interaction-derived signal acquisition, token derivation, encrypted memory indexing, similarity matching, and continuity restoration across user-interface nodes without cloud dependency.

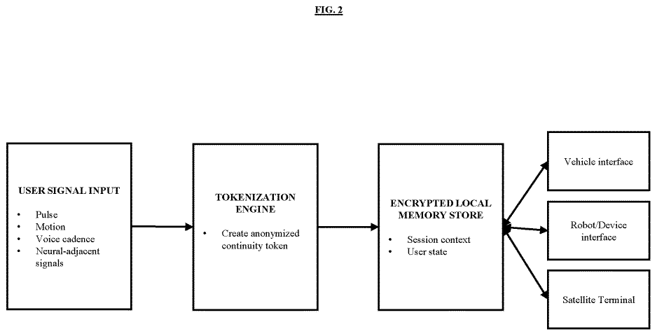

FIG. 3 illustrates an example neural-echo continuity flow showing passive buffering of non-semantic physiological or neural-adjacent signals during sleep or low-interaction states, correlation with waking user interactions, and generation of continuity assistance outputs.

### DETAILED DESCRIPTION OF EMBODIMENTS

The present disclosure provides a technological improvement to privacy-preserving session continuity systems by enabling secure cross-device state restoration without reliance on remote identity servers or persistent biometric storage.

### 6.0 Definitions

As used herein:
“Continuity token” refers to a non-invertible cryptographic value derived from one or more biometric or interaction-derived signals of a user (or digital persona) and a device-specific or environment-specific secret value, and used solely to index locally encrypted continuity state data without storing or transmitting raw biometric measurements.
“Neural-adjacent” signal denotes any physiological or electrical measurement obtained from a sensor positioned proximate to, but not penetrating, the user's skin or skull and processed only as numerical time-series data and statistical pattern signals, explicitly excluding any decoding or determination of specific thoughts, memories, or semantic mental content, and excluding any diagnosis or treatment of medical or mental health conditions.
“Non-semantic interpretation” means statistical or spectral analysis only-no word, memory, intent, or concept is extracted from the signals.
“Memory enhancement signal” refers to a non-verbal output, such as a vibration pattern, tone sequence, light signal, or brief cue, designed to reinforce recall without semantic content.
“Reflection pause” refers to a 0.5-3 second delay in response timing introduced by the system to simulate human thoughtfulness or deliberation.
“Continuity confidence threshold” refers to an acceptance metric, including but not limited to Hamming distance values, probabilistic similarity scoring, or vector distance calculations, used to determine whether two continuity tokens sufficiently correspond to authorize restoration of session context.
“Neural interface signal sensor” refers to any sensor capable of non-invasive acquisition of electrophysiological, electro-dermal, or neural-adjacent signals positioned proximate to the skin or cranial surface without penetrating tissue.
“Local authorization register” refers to a secure, device-resident memory record restricting continuity restoration or enhanced feature access to time-delimited intervals or specific usage conditions upon satisfaction of local cryptographic or biometric authorization conditions.
“Safety governance layer” refers to a software, firmware, or hardware module configured to monitor biometric indicators, user consent, and device tamper conditions and to control memory storage, erasure, authorization state, and continuity restoration according to predefined safety and privacy rules.
“Behavioral modulation engine” refers to a processing module configured to adapt system response timing, interaction cadence, or presentation characteristics based on biometric or interaction-derived measurements to better align with user behavior or preferences.
“Docking interface” refers to a physical and/or electrical interface configured to provide secure, time-limited communication between the continuity anchor device and an external device or station for authentication, diagnostics, firmware updating, or controlled data access.
“Continuity anchor device” refers to a user-associated computing device or secure virtual environment configured to acquire biometric or interaction-derived signals from a user or digital persona and locally execute continuity token derivation, encrypted memory indexing, similarity matching, continuity restoration, cryptographic authorization, and safety-governance operations, the continuity anchor device being implemented in some embodiments as a wearable computing device and in other embodiments as a mobile terminal, headset, vehicle-integrated module, robotic interface node, neural interface endpoint, trusted execution environment, or other user-associated computing platform.
“Non-transitory computer-readable medium” refers to any non-transitory data storage device, including but not limited to random-access memory (RAM), read-only memory (ROM), flash memory, magnetic storage media, or optical disks, and explicitly excludes transitory propagating signals or carrier waves.

### 6.1 System Architecture

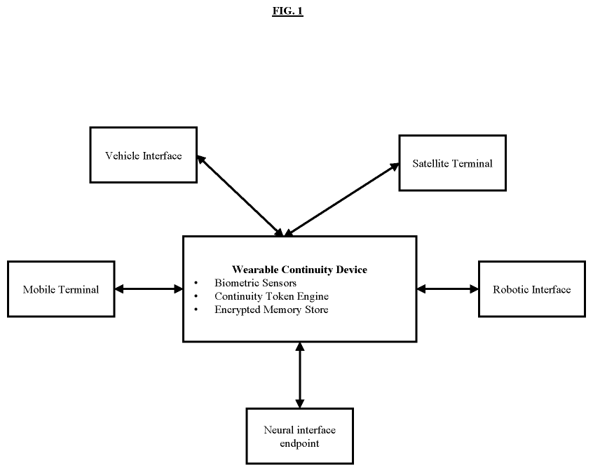

As shown in FIG. 1, the system comprises a continuity anchor device associated with a user. In many embodiments, the continuity anchor device is implemented as a wearable device such as a pendant, bracelet, ring, or head-mounted unit. In other embodiments, the continuity anchor device is implemented as a mobile terminal, vehicle-integrated console, neural interface gateway, robotic node, or other form factor.

The continuity anchor device includes one or more biometric or interaction-derived sensors, such as:
pulse or heart rate sensors;
thermal or skin temperature sensors;
inertial measurement units, accelerometers, or gyroscopes;
electro-dermal or galvanic skin response sensors;
neural-adjacent electrophysiological sensors;
microphones or vocal cadence analyzers;
capacitive, touch, or typing rhythm sensors;
gaze, motion, or additional interaction pattern detectors.

The continuity anchor device executes an identity derivation engine that processes raw sensor data locally to generate a continuity token. This token represents an anonymized biometric or interaction profile. Raw biometric identifiers and feature vectors need not be stored in non-volatile memory, nor transmitted outside the continuity anchor device.

A locally encrypted memory store within or under the control of the continuity anchor device indexes conversational state, session context, user preferences, conversation history fragments, continuity metadata, or other user-interactive information to the continuity token. The encrypted memory store may be implemented using symmetric or asymmetric cryptography and may rely on secure enclaves or trusted execution hardware.

Example: In a vehicular use case, the continuity anchor device (worn as a pendant or integrated into the steering column) detects pulse and motion signals while the user is driving, derives a continuity token, and stores a conversation about navigation preferences, calendar entries, and entertainment selections keyed to the token. Upon the user's arrival home, the same continuity anchor device interacts with a domestic robotic system; the robotic system receives continuity cues from the anchor device and restores the preferences and conversation context seamlessly.

### 6.2 Continuity Restoration

Upon reconnection of the continuity anchor device to any conversational user-interface node, the identity derivation engine acquires fresh biometric or interaction-derived signals and determines whether a previously derived continuity token has been re-detected following one or more interruption events, including:
device transitions;
power loss or reboot;
network interruptions;
idle periods or lapse of user interaction;
removal and re-association of the continuity anchor device with the user.

Upon successful token recognition, the continuity restoration engine retrieves associated session state and re-establishes the contextual conversational environment without requiring network authentication, credential entry, or cloud retrieval of stored memory. Restoration may include resuming a prior dialog, reinstating user-specific preferences, or reconstituting the last known interaction state.

Example: After a two-hour idle period, the continuity anchor device re-detects the continuity token upon sensing a valid live-user biometric pattern and restores a conversation on a mobile terminal, optionally adjusting response latency to match the user's recent typing rhythm.

### 6.3 Conversational User-Interface Nodes

As shown in FIG. 1, conversational user-interface nodes may operate on any computing platform capable of exchanging user-interactive data with the continuity anchor device, including but not limited to:
wearable devices;
vehicles and autonomous transport platforms;
robotic systems or assistive robotics;
mobile terminals or phones;
fixed installations, kiosks, or retail terminals;
entertainment systems or audiovisual terminals;
satellite communication terminals or spacecraft consoles;
head-mounted displays or spatial projection systems;
neural interface endpoints;
cloud-hosted conversational or AI services.

These nodes do not persist long-term personal identity data and rely solely on ephemeral continuity tokens or token references exchanged locally with the continuity anchor device to obtain continuity context. Session data may be streamed from the continuity anchor device or reconstructed based on state information supplied by the continuity anchor device.

Example: In a vehicle-to-robot transition, the continuity anchor device hands off an ongoing conversation about daily tasks from the car's infotainment system to a home robotic assistant without transmitting raw biometric data to either system.

### 6.4 Token Derivation and Encryption

The continuity token is generated using local cryptographic derivation mechanisms incorporating:
biometric or interaction signal preprocessing and normalization;
statistical entropy quantization or feature extraction;
rolling feature vector construction over sliding windows;
cryptographic hashing functions, such as SHA-256 or similar primitives.

Tokens are transient, revocable, and non-invertible, ensuring that personally identifiable biometric or neural signals cannot be reconstructed from the stored continuity data. The continuity anchor device may rotate or refresh continuity tokens periodically or in response to security events.

The encrypted memory store uses symmetric or asymmetric cryptographic encryption to prevent unauthorized extraction of session or identity contextual data. Neither raw biometric data nor full feature vectors are stored in non-volatile memory or transmitted externally. In some embodiments, only truncated token indices and encrypted session payloads are stored.

### 6.4.1 Example Token Generation Algorithm

In one embodiment, the identity derivation engine samples pulse rate and motion data at predetermined sampling frequencies. Pulse rate is sampled at 32-128 Hz and motion from a three-axis accelerometer is sampled at 50-200 Hz. The engine computes, over a sliding time window of 5-20 seconds, a biometric feature vector comprising at least:
(i) an average pulse rate;
(ii) a pulse rate variance;
(iii) an average acceleration magnitude; and
(iv) an acceleration variance.

Each feature is normalized into a bounded numeric range and quantized into a fixed number of bits (for example, 8-12 bits per dimension). The quantized values are concatenated into a feature string and combined with a device-specific secret value stored in a secure enclave. A cryptographic hashing function, such as SHA-256, is applied to the concatenated feature string and device secret to produce a digest. A subset of the digest bits (for example, 128 bits) is used as the continuity token. The token is non-invertible with respect to the underlying biometric measurements.

### 6.4.1.1 Worked Example—Continuity Token Generation and Matching

In one illustrative example:
A pulse sensor reports heart rate samples with an average of 72.4 bpm and variance of 4.1.
A three-axis accelerometer reports motion magnitudes averaging 0.032 g with variance of 0.009.

The identity derivation engine forms a feature vector F=[72.4, 4.1, 0.032, 0.009] and normalizes it to a bounded interval, yielding F′. Each component is quantized into fixed-bit integer representation Q. The quantized values are concatenated into a feature string S. S is concatenated with a device-specific secret D stored in a secure enclave, resulting in X.

A cryptographic hash H=SHA256(X) is computed, and a predetermined subset of bits is truncated to produce the continuity token T. Upon subsequent operation, new biometric samples produce a re-derived vector yielding a second token T′. A token comparison module computes the Hamming distance HD(T, T′) between T and T′. If HD(T, T′) is less than or equal to a threshold (e.g., 10 bits out of 128 bits), the tokens are considered matched and the continuity confidence threshold is satisfied. The indexed continuity state data may then be retrieved from the encrypted local memory store to restore the user session. If the threshold is not satisfied, continuity restoration is denied.

This process ensures robustness to transient biometric fluctuations while preventing reconstruction of underlying biometric measurements from the continuity token.

In informal prototype testing conducted entirely offline using pulse-rate and motion-derived signals, the continuity token system consistently exceeded a same-user matching rate of zero point nine five across repeated sessions, with low false acceptance, without reliance on any network connectivity or centralized identity service.

### 6.4.2 Example Token Matching

When a new continuity token is generated, a token comparison module computes a similarity metric between the new token and one or more previously stored reference tokens. In one embodiment, the similarity metric is a Hamming distance between token bit strings. In other embodiments, similarity may be computed using correlation coefficients, Euclidean or cosine distance in an embedding space, or probabilistic matching.

If the similarity metric between the new token and a stored reference token satisfies the continuity confidence threshold, the system treats the tokens as a match and authorizes retrieval of associated session context. If the similarity metric does not satisfy the threshold for any stored token, continuity restoration is denied, and no session context is loaded.

### 6.4.3 Continuity State Machine Operation

In some embodiments, continuity management is performed using a multi-state execution model. The system operates according to the following states:
1. Enrollment State—the continuity anchor device acquires biometric or interaction-derived signals and generates an initial continuity token associated with a new encrypted session memory entry.
2. Active Continuity State—the system continuously refreshes token derivation for ongoing session verification and may update encrypted session context incrementally.
3. Matching State—upon reconnection, idle interruption, or interface transition, the continuity anchor device computes a re-derived continuity token and compares it to stored tokens using similarity metrics.
4. Authorization State—if confidence thresholds are met, associated session context is restored or partially restored.
5. Revocation State—if mismatch or tamper detection occurs, the associated continuity token and its indexed memory state are invalidated and optionally erased.
6. Re-Enrollment State—upon user consent or security reset, new continuity tokens are generated and continuity resumes.

This state-machine logic is executed locally on the continuity anchor device without reliance on centralized servers or cloud identity services.

A pseudocode representation:

WHILE system_active:
SAMPLES ← acquire_sensor_window( )
F ← normalize_features(SAMPLES)
Q ← quantize(F)
X ← concat(Q, device_secret)
TOKEN_new ← hash(X)
IF stored_tokens empty THEN
store(TOKEN_new, session_state)
state ← ACTIVE
ELSE
match_found ← FALSE
FOR each TOKEN_old in stored_tokens:
IF HAMMING(TOKEN_new, TOKEN_old) <=
threshold THEN
restore_session(TOKEN_old)
state ← AUTHORIZED
match_found ← TRUE
BREAK
IF NOT match_found THEN
deny_continuity( )
state ← REVOKE
END WHILE

### 6.5 Offline Operation

The continuity anchor device and user-interface nodes may function independently of persistent network connectivity. All continuity restoration operations can be executed locally or via direct device-to-device communication mechanisms without cloud dependency.

The system can operate indefinitely in offline mode while still providing continuity restoration based solely on locally stored tokens and encrypted memory. Continuity assistance cues, such as subtle prompts or memory reinforcement signals, do not generate any persistent data outside the continuity anchor device, reinforcing privacy guarantees.

Example: In a remote area without network coverage, the continuity anchor device restores a session from local memory upon reboot and resumes interaction with a nearby offline terminal.

### 6.6 Additional Embodiments—Cognitive Continuity and Liveness Verification

### 6.6.1 Neural Echo/Passive Cognitive Continuity

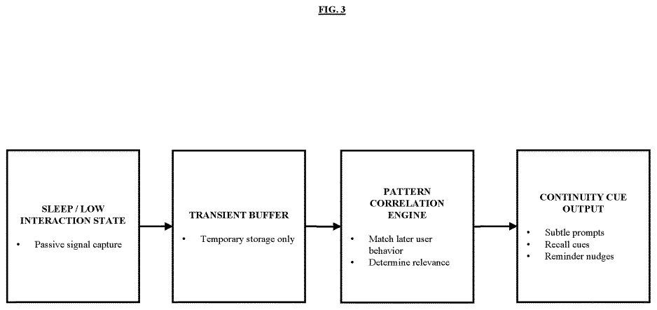

In some embodiments illustrated in FIG. 3, the continuity anchor device may passively detect non-semantic physiological or neural-adjacent signal patterns during periods of reduced interaction or sleep states.

Such signals are:
temporarily buffered in local volatile memory;
summarized into non-semantic statistical measures;
not semantically interpreted or decoded;
not transmitted to any remote system.

Upon subsequent waking interactions, current user activity patterns may be correlated with buffered activity signatures to determine potential contextual relevance. When a correlation threshold is satisfied, the system may generate non-explicit continuity assistance outputs selected from:
subtle prompts;
recall-reinforcement cues;
memory enhancement signals;
nudge notifications.

These outputs do not constitute interpretation of dream content or direct decoding of user thoughts, but serve solely to reinforce continuity between subconscious activity and waking task completion.

In one embodiment, the continuity anchor device samples physiological signals such as heart rate variability and skin conductance at a low sampling frequency (e.g., 0.5-4 Hz) during periods when the user is detected as inactive or sleeping. The sampled values are stored in a circular buffer representing a rolling time window (e.g., 30-90 minutes) and are periodically summarized into numerical statistics. Upon detection of waking interaction, the system computes similarity metrics between the summarized physiological statistics and recent interaction patterns; if a threshold level of correlation is detected, the system triggers a predetermined cue pattern (such as a brief vibration or tone) associated with a previously stored task reminder.

At no point are the buffered physiological signals transformed into decoded semantic content or used for medical analysis.

### 6.6.2 Liveness and Anti-Spoofing Verification

In some embodiments, the continuity anchor device applies liveness validation to ensure continuity authorization is based on genuine live-user biometric sampling rather than spoof replication. Liveness measures may include:
challenge-response testing of pulse-rate variability over randomized sampling windows;
sensor fusion cross-validation between pulse, motion, thermal, and electro-dermal signals to detect physiological coherence;
detection of temporal anomalies inconsistent with continuous biological signal generation;
detection of static or replayed signal patterns indicative of recording attacks.

If spoofing or replay patterns are detected, continuity matching is denied, revocation protocols are initiated, and memory entries may be invalidated or erased according to safety policies.

### 6.7 Privacy and Data Control

No personally identifiable biometric data, raw neural recordings, dream content, or unprocessed sensor streams are stored permanently or transmitted externally. All continuity tokens, buffers, memory indexing, and continuity restoration operations are executed locally under control of the continuity anchor device.

User memory may be selectively retained, erased, or purged based on user preferences, inactivity thresholds, or regulatory requirements. No cloud-based biometric identity storage or centralized session continuity servers are required.

### 6.8 Security and Tamper Protection

The continuity anchor device can include tamper detection circuits, encrypted secure enclaves, write-once memory fusing mechanisms, and hardware integrity checks configured to trigger cryptographic erasure of stored continuity keys, encrypted memory data, and associated continuity tokens upon detection of unauthorized access attempts or tampering.

In docking-enabled embodiments, any external docking station or host device participating in controlled data access is further configured to cryptographically erase temporary session keys, cached continuity data, and authentication credentials upon termination of the session, ensuring that no user memory, continuity state, or biometric-derived data remains accessible outside the continuity anchor device. All such security and tamper protection operations are executed locally and do not depend on network connectivity or cloud services.

### 6.9 Commercial and Software Integration

The system may operate with local transaction authorization mechanisms in which micro-transaction or local access triggers initiate temporary enhanced continuity features or session privileges without dependency on centralized accounts, remote identity servers, or cloud-based validation. In payment-enabled embodiments, the continuity anchor device generates transaction authorization requests, verifies cryptographic receipts or zero-knowledge proofs, and updates a local time-locked authorization register.

Transactions are generated, validated, and recorded locally. Authorization updates are written exclusively to the local authorization register tied to the continuity token. Variable transaction parameters may include session duration, feature access, or other operational enhancements defined by local policy modules. No raw biometric data, detailed continuity state, or network-based identity information is transmitted externally for monetization. Transactions do not rely on network communication for validation, supporting fully offline operation.

Reflection pauses between 0.5 and 3 seconds may be applied to responses to simulate human thoughtfulness, enhance perceived quality, and avoid masking latency. These local transaction authorization mechanisms function independently of biometric identity derivation and remain subordinate to the privacy and safety protections described herein.

### 6.9.1 Micro-Transaction Validation Protocol

In embodiments supporting micro-transactions or local access unlocks, the transaction-based access control module executes a cryptographic validation protocol independent of cloud identity systems. A representative flow includes:
Step A: The continuity anchor device generates a locally issued transaction request containing a time stamp, session continuity token hash reference, feature unlock identifier, and transaction request parameters based on local policy.
Step B: A local or optionally connected payment processing subsystem returns a cryptographic payment confirmation receipt including a transaction validation signature or proof.
Step C: The continuity anchor device validates the receipt using signature verification or zero-knowledge proof techniques without exposure of raw biometric data or full continuity tokens.
Step D: Upon validation, the continuity restoration engine updates a local time-locked authorization register to permit enhanced session functionality or extended access intervals.
Step E: All transaction generation, validation, and authorization operations are executed locally; no continuity state, raw biometric data, or user memory is transmitted externally.

### 6.10 Clinical Disclaimer

The disclosed system does not provide medical diagnosis, mental health evaluation, dream interpretation, or neural therapeutic treatment. Neural-adjacent detection serves only as a passive contextual continuity support mechanism and does not decode neurological content or cognitive intent.

### 6.11 Policy-Adaptive Continuity Operation

In certain embodiments, the biometric continuity token system applies one or more jurisdictional, enterprise, or regulatory policy profiles that dynamically govern the operation of continuity token processing, session state retention, authorization verification, or metadata disclosure behaviors.

Policy profiles may specify that continuity operations execute in one or more selectable compliance modes including:
a) a fully private local-operation mode in which continuity tokens and session memory are generated, stored, matched, and erased exclusively on the continuity anchor device without any external reporting of continuity state or metadata;
b) a regulated compliance mode in which a subset of cryptographically verifiable session metadata or authorization records are escrowed, encrypted, or transmitted to a designated compliance validation endpoint without exposure of raw biometric signals, neural-adjacent signals, or personal interaction content; and
c) a hybrid operation mode in which token derivation and session continuity remain local while authorization or audit confirmation receipts are periodically synchronized to compliance infrastructure systems according to jurisdictional or enterprise rules.

Selection or switching of policy profiles may be configured automatically based on device geolocation, regulatory instruction broadcasts, enterprise security directives, or user-authorized overrides. In all cases, the continuity token derivation, encrypted memory indexing, similarity-matching algorithms, and restoration logic remain locally executed on the continuity anchor device, ensuring that core continuity capabilities operate independently of centralized identity control.

### 6.12 Protocol-Based Continuity Synchronization

In certain embodiments, the system implements a distributed continuity synchronization protocol defining structured message formats, cryptographic continuity identifiers, handshake sequences, reconciliation rules, and state restoration ordering logic for transferring and synchronizing user or agent interaction context across heterogeneous computing platforms.

The protocol governs:
transmission of continuity token references or cryptographic hashes between user-interface nodes and the continuity anchor device;
cryptographically authenticated session-state reconciliation requests and acknowledgments;
conflict resolution handling between partial or concurrent interaction streams originating from different interface nodes;
session restoration staging for continuation of conversational flow following device transitions or network interruptions.

The protocol operates independently of any single interface platform and may be implemented within hardware, firmware, software applications, or virtualized environments across devices operated by differing vendor ecosystems or ownership domains. Protocol execution does not require shared persistent user accounts or centralized identity directories.

### 6.13 Digital Persona and Autonomous Agent Continuity

In certain embodiments, continuity tokens may be derived not only from biometric or interaction-derived human signal sources but additionally from digital persona signatures, behavioral interaction profiles, or autonomous agent state fingerprints representing persistent conversational or operational identities of non-human or semi-autonomous entities.

Accordingly, the continuity system supports session continuity not only between computing platforms associated with human users, but also between interacting digital agents, co-piloting assistants, virtual personas, or neural-simulation-derived identity constructs wherein continuity identification is established via cryptographically derived interaction-state signatures rather than biological anchoring.

The encrypted memory indexing and continuity restoration engines process such persona-derived continuity tokens using the same similarity metrics and threshold confidence mechanisms to preserve persistent conversational context across computing platforms for both human and non-human identity entities.

### 6.14 Hardware-Neutral Anchor Implementations

In certain embodiments, the continuity anchor device may be implemented as a physical wearable apparatus, mobile terminal, implanted computing module, vehicle-integrated computing environment, robotic subsystem node, neural interface gateway, distributed trusted execution container, or fully virtualized cryptographic persona environment.

Such implementations encompass both dedicated hardware anchors and software-instantiated anchors operating within secure enclaves, trusted execution environments, containerized compute nodes, peer-to-peer mesh routers, or ledger-bound cryptographic entities. In all embodiments, the continuity token generation, encrypted memory indexing, similarity matching, authorization updating, and restoration logic remain functionally equivalent, independent of physical or virtual embodiment.

### 6.15 Safety Governance Layer for Continuity Restoration Control

### 6.15.0 Definitions for Safety Governance

“Cryptographic erasure control module” refers to a software, firmware, or hardware module of the continuity anchor device, executed within the secure enclaves or trusted execution hardware of the continuity anchor device, that initiates irreversible cryptographic erasure of stored continuity tokens, encrypted continuity memory, and authorization state by cryptographic wipe of decryption keys required to decrypt or validate said memory upon satisfaction of a defined safety revocation threshold or other defined erasure trigger.

“Consent validation module” refers to a software, firmware, or hardware module of the continuity anchor device that requires active user authorization prior to enabling continuity restoration, evaluates user consent state locally at the continuity anchor device, optionally revalidates consent at predetermined intervals or upon predefined interruption events during active session operations, and is implemented within the continuity anchor device without requiring network-based authentication or centralized identity provider authorization as a prerequisite to consent evaluation.

“Monitoring module” refers to a software, firmware, or hardware module of the continuity anchor device that detects predefined safety conditions including but not limited to inactivity conditions, distress conditions, tamper detection states, and absence indicators by evaluating biometric or interaction-derived signals against one or more predefined temporal thresholds, coherence thresholds, or liveness thresholds within the secure enclaves or trusted execution hardware of the continuity anchor device.

“Compliance adaptation engine” refers to a software, firmware, or hardware module of the continuity anchor device that adapts safety governance thresholds responsive to jurisdictional rule profiles stored locally on the continuity anchor device and selected based on geolocation evidence acquired locally, device policy state, or cryptographically signed policy artifacts verified locally using enclave-resident verification key material, without reliance on cloud-based policy authority servers as a prerequisite to threshold adaptation.

“Governing anchor coupling” refers to an architectural relationship in which a digital persona session or autonomous agent session is associated with a governing continuity anchor device such that continuity restoration of the digital persona or autonomous agent session is conditioned on the safety lock state of the governing continuity anchor device, and such that release of suspension of the digital persona or autonomous agent session requires release of the governing continuity anchor device's safety lock state through locally validated cryptographic authorization at the governing continuity anchor device.

“Safety lock state” refers to a state of the continuity anchor device, established by the safety governance layer in response to detection of a predefined safety condition or satisfaction of a safety revocation threshold, in which continuity restoration is suspended, authorization artifacts are not issued for affected sessions, and exit from the safety lock state requires locally validated cryptographic authorization using locally stored cryptographic key material of the continuity anchor device verified within the secure enclaves or trusted execution hardware.

“Jurisdictional rule profile” refers to a set of safety governance threshold parameters and associated rule logic stored locally on the continuity anchor device that varies based on geographic, legal, or regulatory operational boundaries, and that is selected by the compliance adaptation engine for application to safety governance enforcement based on geolocation evidence, device policy state, or cryptographically signed policy artifacts verified locally using enclave-resident verification key material.

In certain embodiments, the continuity architecture described herein is extended to include a dedicated safety governance layer that operates as an independent, anchor-local module within the continuity anchor device. The safety governance layer continuously monitors biometric indicators, user consent state, device tamper conditions, and absence indicators using signals evaluated locally against predefined temporal, coherence, and liveness thresholds, and conditions continuity restoration on satisfaction of one or more locally evaluated safety conditions. Upon satisfaction of a safety revocation threshold, the safety governance layer initiates irreversible cryptographic erasure of stored continuity tokens, encrypted continuity memory, and authorization state through cryptographic wipe of the decryption keys required to access said memory. All enforcement actions described in this Section 6.15—including consent revalidation, safety lock enforcement, governing-anchor-coupled suspension of associated digital persona or autonomous agent sessions, and physical co-location requirements for safety monitoring signals—execute exclusively within the secure enclaves or trusted execution hardware of the continuity anchor device using locally stored cryptographic key material.

As used in this Section 6.15, the term “safety governance layer” refers to a software, firmware, or hardware module of the continuity anchor device, executed within the secure enclaves or trusted execution hardware of the continuity anchor device, that monitors biometric indicators, user consent, device tamper conditions, and continuity-state indicators, and that controls memory storage, erasure, authorization state, and continuity restoration according to predefined safety and privacy rules. As used in this Section 6.15, the term “safety lock state” refers to a persistent state of the continuity anchor device in which continuity restoration is suspended and remains suspended until released by locally validated cryptographic authorization using locally stored cryptographic key material of the continuity anchor device. As used in this Section 6.15, the term “safety revocation threshold” refers to a predefined criterion evaluated locally by the safety governance layer that, when satisfied, initiates cryptographic erasure of stored continuity tokens and encrypted continuity memory.

The subsections of this Section 6.15 extend, particularize, and add detailed embodiments for the safety governance layer. Remote policy authority enforcement, centralized identity provider authentication, remote account login, cloud-hosted policy server commands, or external recovery mechanisms are insufficient by themselves to authorize continuity restoration, override safety governance decisions, or release a safety lock state absent locally validated cryptographic authorization using locally stored cryptographic key material of the continuity anchor device.

### 6.15.1 Safety Governance Layer Architecture and Module Structure

The safety governance layer, in one embodiment, comprises one or more processors of the continuity anchor device executing program instructions resident within the secure enclaves or trusted execution hardware of the continuity anchor device. The safety governance layer comprises, in various embodiments, a consent validation module, a monitoring module, a cryptographic erasure control module, a safety lock controller, an override interface, and a compliance adaptation engine. Each module is implemented within the secure enclaves or trusted execution hardware of the continuity anchor device and operates on locally stored cryptographic key material that is inaccessible to a general-purpose processor or operating system of the continuity anchor device.

The safety governance layer is configured to execute in a fully offline mode without requiring network connectivity as a prerequisite to enforcing safety governance, erasure, or restoration control. All monitoring, threshold evaluation, cryptographic erasure, safety lock enforcement, and locally validated cryptographic reset operations are executable using only locally stored cryptographic key material of the continuity anchor device.

The safety governance layer interfaces with the identity derivation engine described in Section 6.4, the continuity restoration engine described in Section 6.2, and the locally encrypted memory store described in Section 6.4 such that any continuity restoration decision is conditioned on satisfaction of the safety conditions evaluated by the safety governance layer. In some embodiments, the safety governance layer holds priority over a local authorization register associated with transaction-based access control, such that active monetization authorizations or enhanced feature access are overridden upon detection of a safety revocation event.

### 6.15.2 Consent Validation and Revalidation

The consent validation module, in one embodiment, requires active user authorization prior to enabling continuity restoration. Active user authorization may comprise one or more of: a cryptographically authenticated consent indication received locally at the continuity anchor device; a biometric authentication satisfying a predefined liveness threshold within a predetermined consent-validity window; a touch, gesture, or vocal indication captured by the continuity anchor device and verified against a stored consent reference; or any combination thereof. The consent validation module evaluates active user authorization locally without requiring network-based authentication or centralized identity provider authorization as a prerequisite.

The consent validation module is further configured to revalidate consent at predetermined intervals during active session operations. The predetermined intervals may include, without limitation, fixed time intervals (for example, every 30 minutes during active session operation), variable intervals selected based on session activity patterns, or event-triggered intervals such as detection of an interruption event, an inactivity period, or a session-context change. Upon failure of consent revalidation—meaning that the consent validation module does not receive valid active user authorization within a predefined consent-validity window—the consent validation module suspends continuity restoration, denies agent reinstantiation, and enforces a safety lock state until consent is revalidated.

In a representative non-limiting example, a user wearing a continuity anchor device implemented as a wrist-worn pendant has authorized continuity restoration through a cryptographically authenticated consent indication at session start. After 45 minutes of continuous session activity, the consent validation module reaches a predetermined revalidation interval and prompts the user for reauthorization through a tactile gesture captured by the device. If the gesture is not received within the predefined consent-validity window of 60 seconds, the consent validation module suspends ongoing continuity restoration. The session may not resume until either the user provides a fresh authorization gesture or a locally validated cryptographic reset is executed using locally stored cryptographic key material of the continuity anchor device.

### 6.15.3 Safety Condition Detection—Distress, Inactivity, Tamper, and Absence

The monitoring module is configured to detect at least one predefined safety condition selected from inactivity conditions, distress conditions, tamper detection states, and prolonged absence indicators. Detection is performed using at least one of biometric or interaction-derived signals evaluated against a predefined temporal threshold, coherence threshold, or liveness threshold maintained within the secure enclaves or trusted execution hardware of the continuity anchor device.

A distress condition, in one embodiment, may be detected by evaluating one or more physiological coherence metrics, heart rate variability measurements, electro-dermal activity measurements, or interaction-derived patterns against a predefined distress threshold. In a representative non-limiting embodiment, a distress condition may be determined to exist when, over a sustained measurement interval (for example, a sliding window of 60 to 300 seconds), at least one measured indicator satisfies a predefined distress threshold. Specific representative thresholds include: heart rate variability falling below 20 milliseconds RMSSD; electro-dermal activity exceeding twice a baseline value computed over a preceding 30-minute window; or a behavioral interaction pattern showing more than three standard deviations of deviation from a stored interaction-cadence baseline.

An inactivity condition, in one embodiment, may be detected when no qualifying user interaction signal has been received by the continuity anchor device for a duration exceeding a predefined inactivity threshold. The inactivity threshold may be configurable in a range of, for example, five minutes to several hours depending on policy profile. Detection of an inactivity condition triggers the safety governance layer to require consent revalidation per Section 6.15.2 before continuity restoration is permitted.

A tamper detection state, in one embodiment, may be determined upon receipt of a tamper-event signal from one or more tamper detection circuits of the continuity anchor device. Tamper-event signals may indicate physical opening of the device housing, removal of the device from authorized contact with the user, attempted extraction of memory or key material, exposure to environmental conditions outside operating ranges, or other tamper indicators. Upon detection of a tamper detection state, the monitoring module isolates the continuity anchor device from external synchronization with user-interface nodes and triggers cryptographic erasure of stored continuity tokens and continuity memory through the cryptographic erasure control module.

A prolonged absence condition, in one embodiment, may be detected by evaluating biometric or interaction-derived signals against a configurable temporal threshold indicating that no authenticated user activity has been observed for a sustained period. Detection of a prolonged absence condition triggers the safety governance layer to initiate suspension of continuity restoration. The temporal threshold may be configurable from one or more hours to several days depending on safety policy profile.

Detection of any safety condition by the monitoring module may further trigger denial of agent instantiation, suspension of digital persona or autonomous agent continuity governed by the affected continuity anchor device, and propagation of safety state to the safety lock controller per Section 6.15.5.

### 6.15.4 Cryptographic Erasure Control—Key-Wipe Mechanism and Irreversibility

The cryptographic erasure control module is configured to initiate irreversible cryptographic erasure of stored continuity tokens, encrypted continuity memory, and authorization state upon satisfaction of a safety revocation threshold. The cryptographic erasure mechanism, in one embodiment, comprises cryptographic wipe of the decryption keys required to decrypt or validate said continuity tokens, encrypted continuity memory, and authorization state.

In a representative non-limiting embodiment, the locally encrypted memory store stores agent and user continuity data encrypted under one or more data encryption keys (DEKs). Each DEK is itself protected by a key encryption key (KEK) resident within the secure enclaves or trusted execution hardware of the continuity anchor device. Upon satisfaction of a safety revocation threshold, the cryptographic erasure control module performs cryptographic wipe of the KEK by overwriting the KEK's storage location within the secure enclave with cryptographically secure pseudorandom data, and by invalidating any reference to the KEK in the secure enclave's key registry. Once the KEK is wiped, the DEKs cannot be decrypted, and the encrypted continuity memory becomes computationally infeasible to recover absent a locally validated cryptographic reset that issues a new KEK.

Cryptographic erasure performed by the cryptographic erasure control module prohibits reconstruction of erased continuity memory through docked devices, network-accessible recovery interfaces, cloud-hosted backup services, external key escrow services, or device-possession credential recovery mechanisms external to the continuity anchor device. Remote commands, cloud-based governance signals, centralized account recovery, and centralized identity provider authentication are insufficient to authorize continuity restoration after erasure absent locally validated cryptographic authorization using locally stored cryptographic key material of the continuity anchor device.

The cryptographic erasure control module further disables continuity restoration until an authorized local reset is executed using locally stored cryptographic key material of the continuity anchor device. Locally validated cryptographic reset, in one embodiment, comprises presentation of a cryptographic credential bound to the continuity anchor device's hardware identity, verified within the secure enclaves or trusted execution hardware of the continuity anchor device, and the issuance of a new KEK and DEKs sufficient to enable a fresh enrollment cycle. The locally validated cryptographic reset may not be initiated, executed, or authorized by any remote command, cloud-hosted credential authority, or external identity authority.

### 6.15.5 Safety Lock State and Continuity Suspension

The safety lock controller is configured to maintain a persistent safety lock state of the continuity anchor device upon satisfaction of any safety condition detected by the monitoring module. While in a safety lock state, the continuity anchor device denies all continuity restoration requests, denies all agent reinstantiation requests, and refuses to commit new continuity-state updates until the safety lock state is released through a locally validated cryptographic authorization.

In some embodiments, the safety lock state is implemented as a state flag within a hardware-backed monotonic counter or a tamper-evident state register resident within the secure enclaves or trusted execution hardware of the continuity anchor device. The state flag cannot be reset, cleared, or transitioned out of the safety lock state by any software process, firmware update, external command, or remote authority. Release from the safety lock state requires presentation of a cryptographic credential or attestation token that is verified within the secure enclaves using locally stored cryptographic verification key material.

In some embodiments, the safety lock state may be implemented as a continuity-suspension state in which the encrypted continuity memory is preserved in its current state pending release of the suspension by locally validated cryptographic authorization, rather than triggering immediate cryptographic erasure. Such continuity-suspension embodiments allow recovery of preserved continuity memory upon valid release while still denying continuity restoration during the suspension period. Release of a continuity-suspension state requires locally validated cryptographic authorization using locally stored cryptographic key material of the continuity anchor device. Remote policy authority enforcement, remote commands, and centralized account recovery are insufficient to release a continuity-suspension state absent locally validated cryptographic authorization.

In a representative non-limiting example, a continuity anchor device enters a continuity-suspension state upon detection of a sustained distress condition by the monitoring module per Section 6.15.3. During the suspension, all continuity restoration requests are denied; the encrypted continuity memory remains intact pending release. After clearance of the distress condition or upon recovery of biometric coherence above a recovery threshold, the user presents a cryptographic credential bound to the continuity anchor device's hardware identity at a docking interface. The credential is verified within the secure enclave, and the safety lock controller transitions the device out of the continuity-suspension state. Continuity restoration resumes from the preserved continuity memory.

### 6.15.6 Override Interface and Locally Validated Cryptographic Reset

The override interface is configured to permit release of a safety lock state upon local validation of a cryptographic credential using locally stored cryptographic key material of the continuity anchor device. The override interface verifies presented credentials within the secure enclaves or trusted execution hardware of the continuity anchor device using verification key material that is non-exportable and inaccessible to a general-purpose processor or operating system of the continuity anchor device.

Acceptable override credentials, in one embodiment, comprise one or more of: a hardware-bound cryptographic credential bound to a hardware-derived identifier of the continuity anchor device and signed by an enclave-resident issuing key; a time-limited attestation token signed by the continuity anchor device's enclave-resident signing key during a prior authorized session; or a locally stored recovery credential established during initial device enrollment and protected by tamper-resistant storage within the secure enclave. Remote account login, centralized account recovery, and remote administrative commands are insufficient to release the safety lock state absent locally validated cryptographic authorization.

Override actions executed through the override interface are recorded within a safety state record stored under cryptographic protection within the secure enclaves or trusted execution hardware of the continuity anchor device. The safety state record is maintained locally, is not readable, transferable, or verifiable by any remote service, and provides sufficient information to enforce restoration suspension and reset status.

### 6.15.7 Governing Anchor Coupling and Digital Persona/Autonomous Agent Suspension

As used in this Section, the term “governing continuity anchor device” refers to a continuity anchor device of a human user that has been designated through the coupling record described herein as the safety-state authority for one or more digital persona or autonomous agent sessions. The governing relationship is established at agent enrollment time by recording the coupling record within the secure enclaves or trusted execution hardware of the governing continuity anchor device.

In certain embodiments, a continuity anchor device may be designated as a governing continuity anchor device for one or more digital persona sessions, autonomous agent sessions, or hybrid human-agent operational constructs. The governing anchor relationship may be established at agent enrollment time and recorded within the secure enclaves or trusted execution hardware of the governing continuity anchor device as a coupling record comprising: a continuity token reference for the digital persona or autonomous agent; an attestation artifact establishing the agent's authorized association with the governing continuity anchor device; a coupling policy specifying the conditions under which governing anchor safety state propagates to agent continuity; and a digital signature computed over the coupling record using locally stored cryptographic key material of the governing continuity anchor device.

When the governing continuity anchor device enters a safety lock state per Section 6.15.5, the safety governance layer of the governing continuity anchor device is configured to suspend continuity restoration for all digital persona or autonomous agent sessions whose continuity tokens are recorded in the coupling record. Suspension is enforced by the governing continuity anchor device refusing to issue new authorization artifacts, attestation tokens, or proofs of custody for the affected agent sessions, and by transmitting a locally signed suspension notification to any agent execution node holding an active session indexed to a coupled continuity token.

Suspension of a digital persona or autonomous agent session triggered by governing continuity anchor device safety lock state remains in effect until release of the governing continuity anchor device's safety lock state through locally validated cryptographic reset per Section 6.15.6, or until the coupling record is dissolved through a locally signed dissolution operation executed within the secure enclaves of the governing continuity anchor device.

Remote authorization, cloud-based agent management, federated identity assertion, or external recovery mechanisms are insufficient to override governing-anchor-coupled suspension absent locally validated cryptographic authorization at the governing continuity anchor device. Third-party operator commands, third-party administrative override instructions, and external operator recovery actions are similarly insufficient by themselves to release governing-anchor-coupled suspension absent locally validated cryptographic authorization at the governing continuity anchor device.

In a representative non-limiting example, a user wearing a governing continuity anchor device serves as the governing continuity anchor device for a digital assistant agent operating across mobile and vehicular execution nodes. The user's continuity anchor enters a safety lock state due to detected distress conditions per Section 6.15.3. The safety governance layer of the governing continuity anchor device consults the coupling record, identifies the digital assistant agent's continuity token as a coupled token, and refuses to issue further authorization artifacts for that agent. The agent execution nodes receive locally signed suspension notifications and cease active session operation. The agent remains suspended until the user presents a cryptographic credential to release the governing continuity anchor device's safety lock state, after which the agent's coupled continuity is restored upon presentation of valid attestation per Section 6.15.6.

In some embodiments, the governing anchor coupling may be hierarchical, with a primary governing continuity anchor device and one or more delegated sub-anchors authorized to govern specific subsets of agent sessions under predefined coupling policies. Hierarchical coupling records and propagation rules are maintained within the secure enclaves of the primary governing continuity anchor device and verified locally during each governing-coupled authorization decision.

### 6.15.8 Physical Co-Location of Safety Monitoring Signals and No-Network-Traversal Requirement

In certain embodiments, the monitoring module of the safety governance layer acquires biometric or interaction-derived signals using one or more sensors that are physically co-located on the same hardware substrate as the continuity anchor device. Physical co-location, in one embodiment, means that the sensors and the safety governance layer's monitoring module are disposed within a common physical enclosure, fabricated on a shared semiconductor substrate, or integrated within a single hardware-integrated module of the continuity anchor device, such that safety monitoring signals are acquired and evaluated locally without traversing any network interface prior to safety threshold evaluation.

The physical co-location requirement, in one embodiment, comprises the following structural conditions: (i) the safety monitoring sensors and the secure enclaves or trusted execution hardware of the continuity anchor device communicate over an internal bus, direct electrical connection, or shared semiconductor interconnect that does not include any network interface, wireless transceiver, or external communication port; (ii) raw safety monitoring signals are not transmitted across any network interface prior to evaluation by the monitoring module; and (iii) any safety threshold evaluation result is generated within the secure enclaves or trusted execution hardware of the continuity anchor device before any external transmission of evaluation results.

Any computing environment that requires safety monitoring signals to traverse a network boundary prior to safety threshold evaluation, that performs safety threshold evaluation in a remote service, cloud-hosted analytics platform, or external compute environment, or that relies on network-transmitted safety threshold evaluation results to authorize continuity restoration, does not satisfy the physical co-location requirement of this subsection. Such network-mediated safety monitoring architectures are explicitly excluded from the scope of the safety governance layer as defined herein.

In a representative non-limiting example, a continuity anchor device implemented as a wearable pendant integrates pulse-rate sensors, accelerometers, and electro-dermal activity sensors within the same physical enclosure as the secure enclave executing the safety governance layer. Sensor signals are conveyed over an internal serial peripheral interface to the secure enclave, where the monitoring module evaluates them against distress, inactivity, and absence thresholds. Threshold evaluation results are generated within the secure enclave; only after a safety condition is detected may the safety governance layer transmit a locally signed safety state record to other components of the continuity anchor device. At no point do raw sensor signals traverse any network interface prior to threshold evaluation.

The physical co-location requirement is independent of and additional to the locality requirements of Section 6.15.1; even in embodiments where the safety governance layer's execution is fully local, the physical co-location requirement further constrains the structural arrangement of the safety monitoring sensors with respect to the secure enclaves or trusted execution hardware.

### 6.15.9 Compliance Adaptation Engine and Jurisdictional Rule Profiles

In certain embodiments, the safety governance layer further comprises a compliance adaptation engine configured to adapt safety governance thresholds responsive to one or more jurisdictional rule profiles stored locally on the continuity anchor device. Jurisdictional rule profiles are stored within an encrypted local memory store of the continuity anchor device, protected by locally stored cryptographic key material, and selected based on at least one of geolocation evidence acquired locally by the continuity anchor device, device policy state, or cryptographically signed policy artifacts received and verified locally without reliance on cloud-based policy authority servers.

Each jurisdictional rule profile, in one embodiment, comprises one or more parameters governing the operation of the safety governance layer, including without limitation: thresholds for distress, inactivity, tamper, and absence detection; consent revalidation intervals; safety lock release requirements; and required attestation artifacts for locally validated cryptographic reset. The compliance adaptation engine selects an active jurisdictional rule profile based on at least one of geolocation evidence acquired locally by the continuity anchor device, a cryptographically signed policy artifact verified locally using enclave-resident verification key material, or a user-authorized override executed within the secure enclaves of the continuity anchor device.

The continuity anchor device may operate the safety governance layer under dynamically selectable policy profiles consistent with the policy-adaptive continuity operation of Section 6.11 of the parent disclosure. The selectable policy profiles include, without limitation, a fully private local-operation mode and a regulated-operation mode in which safety governance enforcement remains anchor-local while jurisdictional rule profile selection is constrained by signed jurisdictional policy artifacts verified locally within the secure enclaves of the continuity anchor device.

In all policy modes, safety governance threshold evaluation, cryptographic erasure, safety lock enforcement, locally validated cryptographic reset, governing anchor coupling, and the physical co-location requirement of Section 6.15.8 remain locally executed at the continuity anchor device. Remote commands, cloud-based policy directives, or external authority instructions are not by themselves sufficient to authorize policy mode changes, override safety governance decisions, or release a safety lock state; any such change, override, or release requires anchor-local cryptographic authorization using key material resident within the secure enclaves or trusted execution hardware of the continuity anchor device.

### 6.15.10 Stabilized-Representation Processing for Safety Threshold Evaluation

In some embodiments, safety threshold evaluation by the monitoring module is performed on stabilized intermediate representations of biometric or interaction-derived signals produced within the secure enclaves or trusted execution hardware of the continuity anchor device. Stabilized intermediate representations may be produced by one or more of: a fuzzy extractor; a secure sketch with helper data; a locality-sensitive hashing function applied to quantized feature values; an error-correcting code applied to quantized feature values; or an enclave-internal stabilized feature representation produced by tolerance processing. Stabilized intermediate representations preserve sufficient signal fidelity to enable similarity-based threshold evaluation while reducing sensitivity to small input variations that would otherwise produce large output variations under direct cryptographic hashing.

Direct application of cryptographic hashing functions such as SHA-256 to varying biometric or interaction-derived input signals exhibits avalanche behavior, in which small input changes produce large output changes regardless of input similarity. Direct similarity comparison of cryptographic hash outputs is therefore not suitable for safety threshold evaluation that requires tolerance to natural variation in biometric or interaction signals. The use of fuzzy extractors, secure sketches with helper data, locality-sensitive hashing, error-correcting codes, or enclave-internal stabilized feature representations as described in this Section enables the monitoring module to perform similarity-based threshold evaluation against stored reference values while preserving the non-invertibility and revocability properties of the underlying cryptographic continuity token architecture described in Section 6.4 of the parent disclosure.

In a representative non-limiting example, a heart rate variability signal sampled at 4 Hz over a sliding 60-second window is normalized and quantized within the secure enclave to produce a feature vector. A fuzzy extractor applied to the feature vector produces a stabilized intermediate representation R together with helper data stored within the secure enclave. R is concatenated with a device-specific secret value resident within the secure enclave, and a cryptographic hash function such as SHA-256 is applied to produce a stabilized similarity reference value. Subsequent samples produce stabilized representations R′ that, when processed identically, yield similarity reference values comparable against the stored reference under a similarity metric such as Hamming distance, cosine distance, Euclidean distance, or probabilistic confidence scoring. The monitoring module evaluates the similarity metric against a predefined safety threshold to detect distress, inactivity, tamper, or absence conditions, with similarity-based comparison preserving tolerance to natural signal variation that direct hash-output comparison would not.

Stabilized intermediate representations and their underlying continuity source inputs remain within the secure enclaves or trusted execution hardware of the continuity anchor device. Only the resulting stabilized similarity reference values are exposed for similarity matching against stored reference values within the safety governance layer. Helper data associated with fuzzy extractors or secure sketches is similarly maintained within the secure enclave and is not transmitted externally.

### ALTERNATIVE EMBODIMENTS

The present disclosure may be implemented across a wide range of hardware and software substrates including but not limited to:
wearable pendants, bracelets, rings, or head-mounted devices;
implanted computing modules or medical-grade devices;
hybrid biometric authentication accessories;
vehicle-mounted biometric terminals and infotainment systems;
robotic interface relays and home automation hubs;
satellite uplink identity modules and spaceborne computing systems;
secure virtualization containers or distributed ledger-anchored identities.

Communication methods may include wired ports, wireless RF links, Bluetooth Low Energy (BLE) communications, satellite uplinks, optical transceivers, bio-electrical couplings, or other physical or wireless channels.

Cryptographic derivation algorithms may include but are not limited to hashing, rolling entropy derivation, zero-knowledge proof tokenization, homomorphic encryption-assisted comparisons, or secure enclave-processed biometric transformations.

### Conclusion

The present disclosure enables secure and privacy-preserving continuity of interactive computing sessions across distributed devices without dependence on centralized cloud identity infrastructures or storage of personal biometric identifiers. By employing local continuity token derivation, encrypted local memory indexing, offline-capable continuity restoration, and protocol-based synchronization, the disclosed technology advances the state of biometric and interaction-based continuity computing systems for both human and digital personas.

1. A safety governance system for regulating continuity-based session restoration across heterogeneous user-interface nodes, comprising:
a. a continuity anchor device configured to locally execute continuity token derivation, encrypted memory indexing, similarity matching, and continuity restoration operations;
b. a safety governance layer implemented by one or more processors of the continuity anchor device and configured to monitor biometric indicators, user consent, and device tamper conditions and to control memory storage, erasure, authorization state, and continuity restoration according to predefined safety and privacy rules;
c. a consent validation module configured to require active user authorization prior to enabling continuity restoration, the consent validation module being implemented by the continuity anchor device and evaluating consent locally without requiring network-based authentication or centralized identity provider authorization as a prerequisite;
d. a monitoring module configured to detect at least one predefined safety condition selected from inactivity conditions, distress conditions, tamper detection states, or absence indicators, using at least one of biometric or interaction-derived signals evaluated against a predefined temporal threshold, coherence threshold, or liveness threshold; and
e. a cryptographic erasure control module configured to initiate irreversible cryptographic erasure of stored continuity tokens, encrypted continuity memory, and authorization state by cryptographic wipe of decryption keys required to decrypt said continuity memory upon satisfaction of a defined safety revocation threshold,
wherein the safety governance layer executes locally on the continuity anchor device without requiring remote policy authority enforcement, centralized identity provider authentication, cloud-hosted policy servers, or network connectivity as a prerequisite to enforcing safety governance, erasure, or restoration control, and wherein remote policy authority enforcement, centralized identity provider authentication, remote account login, or external recovery mechanisms are insufficient to authorize continuity restoration or release of a safety lock state absent locally validated cryptographic authorization using locally stored cryptographic key material of the continuity anchor device.

2. The system of claim 1, wherein upon detection of a safety event by the monitoring module, the cryptographic erasure control module invalidates stored continuity tokens and associated encrypted continuity memory, and wherein continuity restoration is prevented until a locally validated cryptographic reset is executed using locally stored cryptographic key material of the continuity anchor device, such that centralized account recovery, remote commands, and external identity authority actions are insufficient to execute said reset.

3. The system of claim 1, wherein the consent validation module revalidates consent at predetermined intervals or upon predefined interruption events during active session operations, and suspends continuity restoration, denies agent instantiation, and enforces a safety lock state when consent revalidation is not satisfied.

4. The system of claim 1, wherein the monitoring module measures at least one safety indicator selected from physiological coherence metrics, heart rate variability measurements, electro-dermal activity measurements, or interaction-derived patterns, and detects a distress condition when at least one measured indicator satisfies a predefined distress threshold for a sustained interval.

5. The system of claim 1, wherein detection of abnormal distress metrics by the monitoring module triggers suspension of continuity restoration and denial of agent instantiation until clearance is validated by satisfaction of a locally evaluated recovery threshold or by locally validated cryptographic authorization using locally stored cryptographic key material of the continuity anchor device, the locally validated cryptographic authorization being verified within secure enclaves or trusted execution hardware of the continuity anchor device.

6. The system of claim 1, wherein detection of a tamper condition by the monitoring module isolates the continuity anchor device from external synchronization with user-interface nodes and initiates cryptographic erasure of stored continuity tokens and continuity memory.

7. The system of claim 1, further comprising an override interface configured to permit release of a safety lock state upon local validation of a cryptographic credential using locally stored cryptographic key material of the continuity anchor device, the cryptographic credential being verified within the secure enclaves or trusted execution hardware of the continuity anchor device using verification key material that is non-exportable and inaccessible to a general-purpose processor or operating system of the continuity anchor device, and wherein remote account login, centralized account recovery, and remote administrative commands are insufficient to release the safety lock state absent locally validated cryptographic authorization.

8. The system of claim 1, wherein continuity restoration of a digital persona or autonomous agent session is suspended when a governing continuity anchor device associated with the digital persona or autonomous agent enters a safety lock state, the suspension being enforced by the governing continuity anchor device refusing to issue authorization artifacts for the affected digital persona or autonomous agent session, and wherein release of suspension requires release of the governing continuity anchor device's safety lock state through locally validated cryptographic authorization at the governing continuity anchor device, and wherein no remote command, no centralized authority action, no third-party operator override, no cloud-hosted policy server signal, and no remote account recovery mechanism is sufficient to release the governing continuity anchor device's safety lock state absent locally validated cryptographic authorization at the governing continuity anchor device using locally stored cryptographic key material verified within the secure enclaves or trusted execution hardware of the governing continuity anchor device.

9. The system of claim 1, further comprising a compliance adaptation engine configured to adapt safety governance thresholds responsive to jurisdictional rule profiles stored locally on the continuity anchor device and selected based on at least one of geolocation evidence acquired locally by the continuity anchor device, device policy state, or cryptographically signed policy artifacts verified locally using enclave-resident verification key material, without reliance on cloud-based policy authority servers.

10. The system of claim 9, wherein the jurisdictional rule profiles vary based on geographic or legal operational boundaries and are stored within an encrypted local memory store of the continuity anchor device.

11. The system of claim 1, wherein an explicit erasure command received at the continuity anchor device triggers cryptographic wipe of decryption keys and optionally of encrypted continuity memory stored in the locally encrypted memory store.

12. The system of claim 1, wherein the cryptographic erasure control module disables continuity restoration until an authorized local reset is executed using locally stored cryptographic key material of the continuity anchor device.

13. The system of claim 1, wherein the monitoring module detects a prolonged absence condition by evaluating biometric or interaction-derived signals against a configurable temporal threshold, and wherein detection of a prolonged absence condition triggers the safety governance layer to initiate suspension of continuity restoration.

14. The system of claim 1, wherein cryptographic erasure performed by the cryptographic erasure control module prohibits reconstruction of erased continuity memory through docked devices, remote commands, centralized account recovery processes, or device-possession credential recovery mechanisms external to the continuity anchor device, the prohibition being enforced by cryptographic wipe of decryption keys required to access said memory, such that remote commands, cloud-based governance signals, centralized account recovery, and centralized identity provider authentication are insufficient to authorize continuity restoration after erasure absent locally validated cryptographic authorization using locally stored cryptographic key material of the continuity anchor device.

15. The system of claim 1, wherein the safety governance layer supersedes local authorization register states associated with transaction-based access control, such that active monetization authorizations are overridden upon detection of a safety revocation event by the monitoring module.

16. A computer-implemented method for enforcing continuity safety governance executed by a continuity anchor device, comprising:
a. validating user consent state prior to enabling continuity restoration, the consent validation being performed locally at the continuity anchor device;
b. monitoring at least one of biometric or interaction-derived signal data to detect predefined safety threshold conditions selected from inactivity conditions, distress conditions, tamper detection states, or prolonged absence indicators;
c. initiating cryptographic erasure of stored continuity tokens and encrypted continuity memory by cryptographic wipe of required decryption keys upon detection of a safety revocation threshold breach; and
d. suspending continuity restoration until locally validated cryptographic release is authenticated using locally stored cryptographic key material of the continuity anchor device,
wherein enforcing continuity safety governance is performed without requiring centralized identity provider authentication, cloud-hosted policy servers, or network connectivity as a prerequisite, and wherein remote policy authority enforcement, remote commands, and external recovery mechanisms are insufficient to authorize continuity restoration or release absent locally validated cryptographic authorization.

17. The method of claim 16, further comprising revalidating user consent at predetermined intervals during active session operations, and suspending continuity restoration upon failure of consent revalidation, the consent revalidation being performed locally at the continuity anchor device using consent validation logic resident within secure enclaves or trusted execution hardware.

18. The method of claim 16, further comprising isolating the continuity anchor device from external synchronization with user-interface nodes upon detection of a tamper condition, and initiating cryptographic erasure of stored continuity tokens.

19. The method of claim 16, further comprising adapting safety governance thresholds responsive to locally stored jurisdictional rule profiles selected based on geolocation evidence, device policy state, or cryptographically signed policy artifacts verified locally using enclave-resident verification key material, without reliance on cloud-based policy authority servers.

20. A non-transitory computer-readable medium storing machine-executable instructions that, when executed by one or more processors of a continuity anchor device, cause the continuity anchor device to:
a. evaluate user consent authorization parameters and require active user authorization prior to enabling continuity restoration, the evaluation being performed locally without requiring network-based authentication as a prerequisite;
b. enforce safety governance rule profiles by monitoring at least one of biometric or interaction-derived safety indicators against predefined temporal, coherence, and liveness thresholds;
c. evaluate a similarity metric between a re-derived continuity token and one or more stored reference continuity tokens against a predefined continuity confidence threshold to authorize continuity restoration, and deny restoration when the similarity metric does not satisfy the continuity confidence threshold;
d. cryptographically invalidate stored continuity tokens and encrypted continuity memory upon detection of a safety revocation threshold breach by wiping decryption keys required to decrypt or validate said memory; and
e. enforce an anchor-local cryptographic authorization condition using locally stored cryptographic key material of the continuity anchor device such that centralized identity provider authentication, remote account login, remote policy authority enforcement, and remote commands are insufficient to authorize continuity restoration or safety lock release absent locally validated cryptographic authorization.

21. The non-transitory computer-readable medium of claim 20, further causing the continuity anchor device to detect a distress condition by evaluating at least one physiological coherence metric, heart rate variability measurement, or electro-dermal activity measurement against a predefined distress threshold, and suspending continuity restoration upon detection.

22. The non-transitory computer-readable medium of claim 20, further causing the continuity anchor device to suspend continuity restoration of a digital persona or autonomous agent session when a governing continuity anchor device associated with the digital persona or autonomous agent enters a safety lock state, the suspension being enforced by refusal to issue authorization artifacts for the affected digital persona or autonomous agent session, and wherein release of suspension requires release of the governing continuity anchor device's safety lock state through locally validated cryptographic authorization, and wherein no remote command, no centralized authority action, no third-party operator override, no cloud-hosted policy server signal, and no remote account recovery mechanism is sufficient to release the governing continuity anchor device's safety lock state absent locally validated cryptographic authorization at the governing continuity anchor device.

23. The non-transitory computer-readable medium of claim 20, further causing the continuity anchor device to adapt safety governance thresholds responsive to locally stored jurisdictional rule profiles without reliance on cloud-based policy authority servers.

24. The system of claim 1, wherein the secure enclaves or trusted execution hardware of the continuity anchor device store locally stored cryptographic key material inaccessible to a general-purpose processor or operating system of the continuity anchor device, and wherein safety governance enforcement operations including cryptographic erasure, safety lock enforcement, and locally validated cryptographic reset are executed at least in part within the secure enclaves or trusted execution hardware.

25. The system of claim 1, wherein continuity restoration is authorized by evaluating a similarity metric between a re-derived continuity token and one or more stored reference continuity tokens against the predefined continuity confidence threshold, the similarity metric being evaluated on stabilized intermediate representations produced within secure enclaves or trusted execution hardware of the continuity anchor device by tolerance processing comprising at least one of a fuzzy extractor, a secure sketch with helper data, a locality-sensitive hashing function, or an error-correcting code, and wherein the safety governance layer monitors successive failures of the continuity confidence threshold by evaluating said similarity metric over successive re-derivations.

26. The system of claim 1, wherein all safety governance enforcement actions comprising cryptographic erasure, safety lock enforcement, and locally validated cryptographic reset are executable only using locally stored cryptographic key material of the continuity anchor device verified within the secure enclaves or trusted execution hardware, and wherein no remote command is sufficient to initiate, override, or reverse any safety governance enforcement action absent locally validated cryptographic authorization.

27. The system of claim 1, wherein the safety governance layer operates without network connectivity as a prerequisite, and wherein all safety governance monitoring, erasure initiation, consent validation, and locally validated cryptographic reset operations are executable in a fully offline mode.

28. The system of claim 1, wherein the similarity metric used by the continuity anchor device to evaluate continuity token correspondence against the predefined continuity confidence threshold comprises at least one of Hamming distance, cosine distance, Euclidean distance, correlation scoring, or probabilistic confidence scoring, the similarity metric being evaluated on stabilized intermediate representations produced within secure enclaves or trusted execution hardware of the continuity anchor device, and wherein safety governance monitoring uses the same similarity metric evaluation to detect successive failures of the continuity confidence threshold indicative of safety-relevant continuity anomalies.

29. The system of claim 1, wherein continuity tokens and encrypted continuity memory subject to safety governance erasure are not reconstructible through docked devices, network-accessible recovery interfaces, cloud-hosted backup services, or external key escrow services after cryptographic erasure, the cryptographic erasure being irreversible absent a locally validated cryptographic reset executed using locally stored cryptographic key material of the continuity anchor device verified within the secure enclaves or trusted execution hardware.

30. The system of claim 1, wherein the monitoring module acquires biometric or interaction-derived signals using one or more sensors physically co-located on the same hardware substrate as the continuity anchor device such that safety governance monitoring signals are acquired and evaluated locally within secure enclaves or trusted execution hardware of the continuity anchor device without traversing any network interface prior to safety threshold evaluation, and wherein any computing environment that requires safety monitoring signals to traverse a network boundary prior to threshold evaluation does not satisfy this requirement.
